(19) United States
(12) Patent Application Publication
(10) Pub. No.: US 2020/0215898 A1
(43) Pub. Date: Jul. 9, 2020

(54) METHOD FOR OPERATING A DRIVETRAIN OF A MOTOR VEHICLE, AND DRIVETRAIN FOR A MOTOR VEHICLE

(71) Applicant: AUDI AG, Ingolstadt (DE)

(72) Inventors: Michael WEIN, Seubersdorf (DE); Michael BAER, Ingolstadt (DE)

(73) Assignee: AUDI AG, Ingolstadt (DE)

(21) Appl. No.: 16/631,240

(22) PCT Filed: Aug. 21, 2018
(86) PCT No.: PCT/EP2018/072571

§ 371 Date: Jan. 15, 2020

(30) Foreign Application Priority Data
Sep. 4, 2017 (DE) 10 2017 215 477.2

(51) Int. Cl. B60K 6/52; B60K 6/387; B60W 10/02; B60W 10/08; B60W 10/119

(52) U.S. Cl. CPC B60K 6/52; B60K 6/387; B60W 10/119; B60W 10/08; B60W 10/02

(57) ABSTRACT

A method for operating a drivetrain of a motor vehicle comprising an engageable and disengageable four-wheel drive and at least two intermeshing gears, in which the four-wheel drive is switched off by the opening of at least one clutch of the drivetrain, wherein a change of engagement of the gears resulting from the switching off is actively braked by an electric machine of the drivetrain.

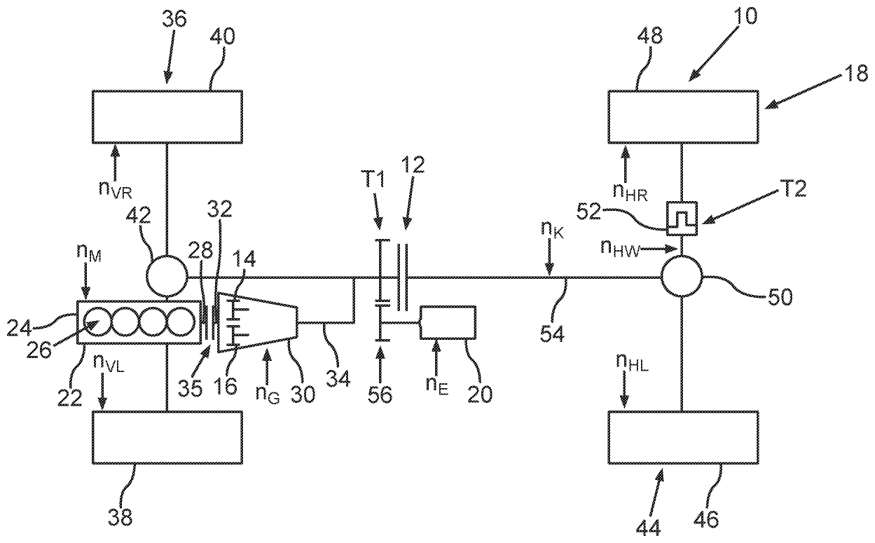

The invention relates to a method for operating a drivetrain of a motor vehicle, especially a passenger car, according to the preamble of patent claim 1. Moreover, the invention relates to a drivetrain for a motor vehicle, especially for a passenger car, according to the preamble of patent claim 6.

Such methods for operating a drivetrain of a motor vehicle, especially a passenger car, and such drivetrains for a motor vehicle are rather well known from the general prior art. The drivetrain comprises an engageable and disengageable four-wheel drive, at least two intermeshing gears, and at least one clutch which can be shifted from a closed state to an opened state for switching off the four-wheel drive. This means that, in the respective method, the four-wheel drive is switched off by opening the clutch of the drivetrain.

Furthermore, EP 2 786 910 A1 discloses a control device for a hybrid vehicle, which is outfitted with an internal combustion engine. Moreover, the hybrid vehicle comprises an electric machine.

Furthermore, there is known from DE 10 2007 037 530 A1 a transmission apparatus for a vehicle.

The problem which the present invention proposes to solve is to modify a method and a drivetrain of the above mentioned kind so that an especially comfortable operation can be realized.

This problem is solved according to the invention by a method having the features of patent claim 1, and also by a drivetrain having the features of patent claim 6. Advantageous embodiments with expedient modifications of the invention are indicated in the other claims.

A first aspect of the invention relates to a method for operating a drivetrain of a motor vehicle, especially a passenger car. The drivetrain or the motor vehicle comprises an engageable and disengageable four-wheel drive and at least two intermeshing gears. By the feature that the gears are intermeshing is meant in particular that the gears have respective toothings which engage with each other. In this way, the gears interact in form fitting, so that at least one torque can be transmitted from one of the gears to the other respective gear, and vice versa. In the method, the four-wheel drive is switched off by the opening of at least one clutch of the drivetrain. The clutch is also called a four-wheel or all-wheel clutch, for example.

Now, in order to realize an especially comfortable operation of the drivetrain and thus of the motor vehicle as a whole, it is provided according to the invention that a change of engagement of the gears resulting from the switching off is actively, i.e., specifically braked by means of an electric machine. By active or specific braking of the change of engagement is meant that the electric machine is operated specifically, in particular, controlled or regulated in order to specifically and thus consciously or deliberately brake the change of engagement. By the braking of the change of engagement is meant in particular that the change of engagement occurs more slowly or with lower rotational speed or rotational velocity of the gears than if no such braking were done. Due to the specific braking of the change of engagement, this can occur gently and thus with little noise, so that excessive noise resulting from the switching off of the four-wheel drive can be prevented.

The invention is based in particular on the awareness that, during the switching off of the four-wheel drive, there may traditionally occur an abrupt unloading or relaxation of the drivetrain. During such an abrupt unloading in traditional drivetrains, the gears which are in engagement with each other and which are used for example in an axle transmission or main transmission execute an abrupt change of engagement, and thus a change with a high rotational speed or rotational velocity, which may result in noise. This noise may be perceived acoustically by passengers of the motor vehicle, so that the ride comfort may be impaired. These problems and drawbacks can now be avoided by means of the method according to the invention, since the change of engagement, also known as gear flank change, is actively and thus specifically braked.

The change of engagement is produced for example by a torque acting on at least one of the gears and resulting from the switching off of the four-wheel drive, and this torque is actively counteracted by means of the electric machine for example by the braking of the change of engagement. In this way, an excessively abrupt change of engagement can be prevented in an assured manner.

The drivetrain comprises for example at least one additionally provided drive motor different from the electric machine, which is designed for example as a combustion engine. Furthermore, the drivetrain comprises for example a first axle drivable by the drive motor and a second axle drivable by the drive motor across the clutch. The first axle is for example a primary axle, while the second axle is a secondary axle of the drivetrain. Preferably the second axle is decoupled from the drive motor upon switching off the four-wheel drive, especially while the first axle remains coupled to the drive motor or is drivable by the drive motor.

The drivetrain comprises for example at least or exactly four wheels, which are basically drivable for example by the drive motor. Two first ones of the wheels are assigned for example to the first axle, so that the first axle comprises the first wheels. Two second ones of the wheels are assigned for example to the second axle, so that the second axle comprises the second wheels. If the four-wheel drive is switched on or activated, and the drive motor provides a torque also known as the driving torque or driving moment, the four wheels are driven by the drive motor, that is, by means of the drive torque, especially if the four wheels are coupled to the drive motor when the four-wheel drive is switched on. If the four-wheel drive is switched on or activated, the drivetrain or the motor vehicle will be operated in a four-wheel operation. If the drivetrain comprises for example exactly four wheels, the four-wheel drive is also known as all-wheel drive and the four-wheel operation is also known as all-wheel operation.

But if the all-wheel drive is switched off or deactivated, then only the first wheels for example of the four wheels are drivable by the drive motor, since only the first wheels of the four wheels are coupled to the drive motor, while the second wheels are decoupled from the drive motor. Thus, if the drive motor provides a driving torque when the four-wheel drive is switched off, then only the first wheels of the four wheels are driven, while there is no driving of the second wheels by the drive motor. If the four-wheel drive is switched off, the drivetrain or the motor vehicle will be operated in a two-wheel operation. In the two-wheel operation, the clutch is opened, whereas the clutch is closed in the four-wheel operation.

The clutch is designed for example as a frictional clutch or friction-locking clutch, and in particular the clutch may be designed as a multi-plate clutch. If the clutch is closed or the four-wheel drive is switched on, so too are the axles of the motor vehicle, also known as the driving axles, coupled together across the clutch. This coupling of the two axles results, for example when taking a curve or when there are tire circumference differences, in stresses in the drivetrain if the clutch is closed. If the clutch is then opened, for example in order to enable an especially advantageous maneuvering, especially with only a slight turn radius, the aforementioned abrupt unloading or relaxing of the drivetrain may occur in traditional drivetrains. In order to avoid an excessively abrupt change of engagement and the resulting noise, the electric machine according to the invention is specifically operated, especially controlled or regulated when the four-wheel drive is switched off, so as to specifically and thus actively brake the change of engagement.

Preferably, the electric machine is given a dual function, since it is utilized on the one hand to brake the change of engagement. On the other hand, the electric machine is utilized for example as a generator and/or electric motor. The generator is also known as a drivetrain generator. In order to utilize the electric machine as a generator, the electric machine is operated for example in a generator mode. In this case, the electric machine is driven for example by the drive motor and/or across at least two of the wheels and thus by means of kinetic energy of the motor vehicle, so that for example at least a portion of the kinetic energy and/or energy provided by the drive motor can be transformed by means of the generator into electrical energy.

Alternatively or additionally, the electric machine is operated as an electric motor, for example, in order to drive at least two wheels and thus the motor vehicle as a whole. For this, the electric machine in its motor mode provides torques for the driving of at least two of the wheels. Hence, for example, it is conceivable to utilize the electric machine which is present in any case in a hybrid vehicle in order to specifically brake the change of engagement by means of the electric machine. The use of an electric machine on a drivetrain is basically detrimental in terms of avoiding the noise resulting from a change of engagement, since the electric machine, especially its rotor, usually has a large mass, which may intensify the change of engagement and its resulting noise. This is especially the case when the electric machine is not operated specifically during the switching off of the all-wheel drive, as in traditional drivetrains, in order to dampen the change of engagement. But according to the invention it is now possible to utilize the electric machine which is present in any case in order to brake and thus dampen the change of engagement, so that the electric machine brakes or dampens, rather than intensifies the change of engagement.

The braking of the change of engagement is thus an auxiliary function, which can be realized with no additional costs and no additional components. Consequently, an especially comfortable operation can be realized. Moreover, additional components such as dampening and frictional elements for the dampening of the change of engagement can be avoided, so that the number of parts, the design space requirement, and the costs of the drivetrain can be kept low. Furthermore, a friction optimization can be achieved in this way, so that an especially efficient and thus low energy-consuming operation of the drivetrain can be realized.

A further embodiment is characterized in that the drivetrain comprises at least one transmission, especially a main transmission, across which the axles are drivable by the drive motor.

It has proven to be especially advantageous for a traction operation of the transmission to be carried out for the braking of the change of engagement by means of the electric machine. In other words, it is advantageously provided that the transmission is kept under traction by means of the electric machine, in order to dampen the change of engagement. In traditional drivetrains, a coasting operation of the transmission results at least briefly upon switching off the four-wheel drive, and as a result of the coasting operation there occurs an abrupt and thus noise-causing change of engagement. This can now be specifically prevented.

Finally, it has proven to be especially advantageous for the electric machine to provide at least one torque to bring about the traction operation of the transmission, which is introduced into the transmission by the electric machine. For example, the electric machine is operated as an electric motor in this case, in order to specifically counteract an excessively abrupt change of engagement.

A second aspect of the invention relates to a drivetrain for a motor vehicle, especially for a passenger car. The drivetrain comprises an engageable and disengageable four-wheel drive, at least two intermeshing gears, and at least one clutch, which can be shifted from a closed state to an opened state for the switching off of the four-wheel drive.

Now, in order to realize an especially comfortable operation of the drivetrain and thus of the motor vehicle as a whole in especially simple manner, it is provided according to the invention that the drivetrain comprises at least one electric machine, which is adapted to actively brake and thus dampen a change of engagement of the gears resulting from the switching off. In other words, the drivetrain according to the invention is adapted to carry out a method according to the invention. Benefits and advantageous embodiments of the first aspect of the invention are to be regarded as benefits and advantageous embodiments of the second aspect of the invention and vice versa.

Thus, in the second aspect of the invention, an electronic computing device is provided, which is adapted to actuate and thus regulate or control the electric machine. In particular, the electronic computing device is adapted to actuate the electric machine specifically, especially in dependence on at least one parameter characterizing the current state of the drivetrain, so that the electric machine actively brakes and thus dampens the change of engagement.

Further benefits, features and details of the invention will emerge from the following description of a preferred exemplary embodiment, as well as the drawing. The features and combinations of features mentioned above in the specification as well as the features and combinations of features mentioned hereafter in the description of the FIGURE and/or shown alone in the single FIGURE can be used not only in the particular indicated combination, but also in other combinations or standing alone, without leaving the scope of the invention.

The drawing shows in the single FIGURE a schematic representation of a drivetrain according to the invention for a motor vehicle, the drivetrain being designed to carry out the method according to the invention.

The single FIGURE shows in a schematic representation a drivetrain for a motor vehicle designed as a passenger car, for example, being denoted overall by reference number 10. The drivetrain 10 comprises a clutch 12, for example one designed as a frictional clutch, especially a multi-plate clutch, which is also known as an all-wheel clutch. Furthermore, the drivetrain 10 comprises at least two intermeshing gears 14 and 16, shown in particular schematically in the FIGURE. The gears 14 and 16 have respective toothings which engage with each other. In this way, the gears 14 and 16 interact by form fitting, so that for examples torques can be transmitted from one of the gears 14 and 16 to the other respective gear 16 or 14 and vice versa. The drivetrain 10 moreover comprises an engageable and disengageable four-wheel drive 18. In order to switch on and thus activate the at first switched off and thus deactivated four-wheel drive 18, for example, the clutch 12 is shifted for example from an opened to a closed state. In order to switch off and thus activate the at first switched on and thus activated four-wheel drive 18, for example, the clutch 12 is shifted for example from its closed state to its opened state. The shifting of the clutch 12 from the opened state to the closed state is also known as a closing of the clutch 12, while the shifting of the clutch 12 from the closed state to the opened state is also known as an opening of the clutch 12.

In the following, a method for operating the drivetrain 10 will be explained with the aid of the FIGURE. In the method, the at first switched on four-wheel drive 18 is switched off by opening at least the clutch 12, also known as the all-wheel clutch.

Now, in order to realize an especially comfortable operation of the drivetrain 10 and thus of the motor vehicle as a whole, it is proposed in the method that a change of engagement of the gears 14 and 16 resulting from the switching off of the four-wheel drive 18 is actively braked and thus dampened by means of an electric machine 20 of the drivetrain 10. In this way, excessive noise resulting from the change of engagement can be avoided, so that an especially good ride comfort can be achieved.

It can be seen from the FIGURE that the drivetrain 10 comprises at least one additionally provided drive motor 22, different from the electric machine, which in the present instance is designed as an internal combustion engine or a combustion engine. Alternatively, it is conceivable for the drive motor 22 to be designed as a further electric machine. The drive motor 22 designed in the present case as a combustion engine comprises a cylinder housing 24, by which multiple combustion chambers in the form of cylinders 26 are formed. The drive motor 22 comprises an output shaft 28, which is designed for example as a crankshaft. The drive motor 22 may provide torques for the driving of the motor vehicle across the output shaft, especially in a traction operation of the drive motor 22, these torques being known as driving torques or driving moments for the driving of the motor vehicle.

The drivetrain 10 moreover comprises a transmission 30, known as the main transmission, comprising for example the gears 14 and 16. The transmission 30 here comprises a transmission input shaft 32, which is drivable for example across a starting element 35 by the output shaft 28 and thus by the drive motor 22. The starting element 35 is designed for example as a friction-locking clutch and thus as a friction clutch or separating clutch. Moreover, the transmission 30 comprises a transmission output shaft 34, by which the transmission 30 can provide torques for the driving of the motor vehicle. The transmission output shaft 34 is thus drivable by the transmission input shaft 32 and across this and across the starting element 35 by the output shaft 28. For example, the clutch 12 is drivable by the transmission output shaft 34, so that the clutch 12 is itself drivable across the transmission output shaft 34, the transmission input shaft 32 and the starting element 35 by the output shaft 28 and thus by the drive motor 22. In other words, the driving torques provided by the drive motor 22 across the output shaft 28 are channeled across the output shaft 28, the starting element 35, the transmission input shaft 32 and the transmission output shaft 34 into the clutch 12.

The drivetrain 10 moreover comprises a first axle, designed as a front axle 36, which is also known as the primary axle, and having first wheels in the form of front wheels 38 and 40. The front wheels 38 and 40 are drivable across the transmission 30 by the drive motor 22, especially bypassing the clutch 12. The front axle 36 comprises an axle transmission 42, in addition to and different from the transmission 30, which is also known as the front axle transmission and is designed as a differential, especially a bevel gear differential transmission.

Furthermore, the drivetrain 10 comprises a second axle in the form of a rear axle 44, having second wheels in the form of rear wheels 46 and 48. The rear axle 44 comprises a second axle transmission 50, in addition to and different from the transmission 30 and the axle transmission 42, which is also known as the rear axle transmission and is designed for example as a differential, especially a bevel gear differential transmission.

The front wheels 38 and 40 are drivable across the axle transmission 42 and the main transmission by the drive motor 22. The rear wheels 46 and 48 are drivable across the axle transmission 50, the clutch 12 and the main transmission by the drive motor 22. If the four-wheel drive 18 is switched off by opening the clutch 12, the rear axle 44 and hence the rear wheels 46 and 48 are decoupled from the drive motor 22, while the front axle 36 and hence the front wheels 38 and 40 are coupled to the drive motor 22. In this way, when the drive motor 22 is providing driving torques, only the front wheels 38 and 40 but not the rear wheels 46 and 48 of the four wheels are driven, so that the drivetrain 10 is operated in a two-wheel mode. But if the four-wheel drive 18 is switched on by closing the clutch 12, then when the drive motor 22 is providing driving torques both the front wheels 38 and 40 and the rear wheels 46 and 48 are driven, so that the drivetrain 10 is operated in a four-wheel operation. Since the drivetrain 10 in the exemplary embodiment shown in the FIGURE has only the four wheels, the four-wheel drive 18 is an all-wheel drive, so that the four-wheel operation is an all-wheel operation.

Hence, if the clutch 12 is opened, the rear wheels 46 and 48 will be decoupled from the drive motor 22. Hence, the clutch 12 is utilized to create a first separation point T1.

In order to realize a second, rear separation point T2 with respect to the first separation point T1, a form-fitting coupling device is used, designed in the present case as a claw clutch 52. The claw clutch 52 is optionally provided and could be omitted. The claw clutch 52 can be moved between at least one decoupling position and at least one coupling position. In the decoupling position, a flow of force in the drivetrain 10 is interrupted at the second separation point T2. In the coupling position, the flow of force in the drivetrain 10 is closed in form-fitting manner by means of the claw clutch 52 at the second separation point T2. In the coupling position, the rear wheels 46 and 48 are coupled by the claw clutch 52 in form fitting manner with a shaft of the drivetrain 10, designed as a Cardan shaft 54, while the Cardan shaft 54 is or can be driven by the drive motor 22 across the clutch 12 and the transmission 30 when the clutch 12 is closed and the drive motor 22 is providing driving torques. Hence, if the claw clutch 52 is closed, the rear wheels 46 and 48 can be driven in form fitting by the Cardan shaft 54, especially when the Cardan shaft 54 is driven. In the decoupling position, however, the rear wheels 46 and 48 are decoupled from the Cardan shaft 54, by which is meant that in the decoupling position of the claw clutch 52 the rear wheels 46 and 48 are not coupled across the claw clutch 52 with the Cardan shaft 54. Hence, in the decoupling position of the claw clutch 52 the rear wheels 46 and 48 are not driven across the claw clutch 52 by the Cardan shaft 54 and vice versa.

Preferably, if the four-wheel drive 18 is switched off, both the clutch 12 and the claw clutch 52 are opened, so that the Cardan shaft 54 is stationary and driven neither by the rear wheels 46 and 48 nor by the drive motor 22. In this way, an especially efficient two-wheel operation can be achieved.

The electric machine 20, especially its rotor, is coupled for example with the transmission output shaft 34, especially across an optionally provided spur gear state 56. The electric machine 20 for example can be operated in a motor mode and thus as an electric motor and/or in a generator mode and thus as a generator. In the motor mode, the electric machine 20 can provide torques, for example, by means of which the wheels can be driven, especially depending on whether the four-wheel drive 18 is switched on or switched off. When the four-wheel drive 18 is switched on, the electric machine 20 can drive the front wheels 38 and 40 and the rear wheels 46 and 48, while the electric machine 20 when the four-wheel drive 18 is switched off can only drive the front wheels 38 and 40. The electric machine 20 is thus a drive motor provided in addition to the drive motor 22, for example, by means of which the wheels can be electrically driven. Hence, the motor vehicle is designed for example as a hybrid vehicle.

Furthermore, respective rotational speed sensors are provided, by means of which respective rotational speeds of the front wheels 38 and 40, the output shaft 28, the electric machine 20, especially the rotor of the electric machine 20, the Cardan shaft 54, the rear wheels 46 and 48 and for example a rotational speed of a side shaft or a ring gear of the axle transmission 50 can be detected. Moreover, a rotational speed sensor is provided for example for detecting a rotational speed of the transmission 30, the rotational speed of the transmission 30 being a rotational speed of the transmission input shaft 32 or the transmission output shaft 34. The notations in the FIGURE are:
n_{VL} the rotational speed of the front wheel 38
n_{M} the rotational speed of the output shaft 28
n_{VR} the rotational speed of the front wheel 40
n_{G} the rotational speed of the transmission 30
n_{E} the rotational speed of the electric machine 20, especially its rotor
n_{K} the rotational speed of the Cardan shaft 54
n_{HL} the rotational speed of the rear wheel 46
n_{HR} the rotational speed of the rear wheel 48
n_{HW} the rotational speed of the side shaft or ring gear

In the process of switching off the four-wheel drive 18, the rear axle 44 is decoupled from the drive motor 22 by opening the clutch 12 and optionally the claw clutch 52. For example, a traction operation of the transmission 30 is produced for the braking of the change of engagement of the gears 14 and 16 by means of the electric machine 20, especially by operating the electric machine 20 as an electric motor and thus providing at least one torque, which is channeled from the electric machine 20, especially from its rotor, into the transmission 30. In particular, the change of engagement is braked in dependence on at least one of the mentioned rotational speeds so that the electric machine 20 is operated and in particular controlled or regulated for the braking of the change of engagement in dependence on the at least one rotational speed.

Since the electric machine 20 is utilized to brake the change of engagement, additional and separate components such as dampening and frictional elements for the dampening of the change of engagement can be avoided, so that the number of parts, the weight, and the costs of the drivetrain 10 can be kept within an especially low range. Furthermore, the costs, the weight, and the design space requirement of the drivetrain 10 can be kept especially low, since the electric machine 20 takes on a dual function. On the one hand, the electric machine 20 is utilized for the electrical driving of the wheels. On the one hand, the electric machine 20 is utilized for the specific and hence active braking of the change of engagement, so that an especially good ride comfort can be achieved.

1-6. (canceled)

7. A method for operating a drivetrain of a motor vehicle comprising:
an engageable and disengageable four-wheel drive and at least two intermeshing gears, in which the four-wheel drive is switched off by the opening of at least one clutch of the drivetrain,
wherein a change of engagement of the gears resulting from the switching off is actively braked by means of an electric machine of the drivetrain.

8. The method according to claim 7, wherein the drivetrain comprises at least one drive motor different from the electric machine, a first axle drivable by the drive motor and a second axle drivable by the drive motor across the clutch, which is decoupled upon switching off the four-wheel drive from the drive motor.

9. The method according to claim 8, wherein the drivetrain comprises at least one transmission, across which the axles are drivable by the drive motor.

10. The method according to claim 9, wherein a traction operation of the transmission is carried out for the braking of the change of engagement by means of the electric machine.

11. The method according to claim 10, wherein the electric machine provides at least one torque to bring about the traction operation of the transmission, which is introduced into the transmission by the electric machine.

12. A drivetrain for a motor vehicle comprising:
an engageable and disengageable four-wheel drive, with at least two intermeshing gears and with at least one clutch, which can be switched from a closed state to an opened state in order to switch off the four-wheel drive,
wherein the drivetrain comprises at least one electric machine, which is adapted to actively brake a change of engagement of the gears resulting from the switching off.
